(19) United States
(12) Patent Application Publication
(10) Pub. No.: US 2020/0378933 A1
(43) Pub. Date: Dec. 3, 2020

(54) PEAK DETECTION METHOD AND DATA PROCESSING DEVICE

(71) Applicant: SHIMADZU CORPORATION, Kyoto-shi, Kyoto (JP)

(72) Inventors: Shinji KANAZAWA, Kyoto-shi (JP); Hiroaki KOZAWA, Kyoto-shi (JP)

(73) Assignee: SHIMADZU CORPORATION, Kyoto-shi, Kyoto (JP)

(21) Appl. No.: 16/305,711

(22) PCT Filed: May 30, 2016
(86) PCT No.: PCT/JP2016/065915

§ 371 Date: Nov. 29, 2018

(51) Int. Cl. G01N 30/86

(52) U.S. Cl. CPC G01N 30/8637

(57) ABSTRACT

The peak detection method of the present invention is a method of detecting peaks from data of a graph representing change in measured value relative to a measurement variable, comprising: a wavelet transform step (S2) in which wavelet transform is performed on the aforementioned data using a mother wavelet having a single maximum value to find an evaluation function having said mother wavelet's scale and translation as parameters; and a peak candidate information acquisition step (S3 through S5) in which locations of peak candidates in the aforementioned data are found based on the translation at which said evaluation function has its maximum value, and the width of said peak candidates is determined based on the scale corresponding to said peak candidates. Performing wavelet transform makes it possible to detect peak candidates regardless of the strength or weakness of peaks, etc., and to determine the width of peak candidates, which serves as an index for discriminating whether or not the peak candidate is a true peak.

### TECHNICAL FIELD

The present invention relates to a method of detecting peaks, for example, from chromatograms obtained with a chromatograph or from a spectrum obtained with a mass analysis device, spectroscope or the like, and to a data processing device which executes said method.

### BACKGROUND ART

Devices for analysis components contained in a sample include chromatographs. In a chromatograph, a sample is introduced into a column with the flow of a liquid phase, the components in the sample are separated in time in the column, and are then detected with a detector to generate a chromatogram. Peaks are then detected from the chromatogram, the components are identified based on peak location, and the concentrations of the components are determined based on peak height and area (for example, see patent document 1). For these operations, processing is performed in software to automatically detect the peaks from the chromatogram. Automatic detection of peaks is similarly performed on spectra.

Non-patent document 1 describes detecting peaks from a mass spectrum using wavelet transform. It should be noted that this method is not limited to mass spectra and can be applied to wavelength spectra, chromatograms, etc. Generally, wavelet transform employs a function called mother wavelet ψ (t), which is a function of variable t representing an isolated (localized in time) wave and has a constant called scale, representing dilation/contraction along the horizontal axis, and a constant called translation, representing parallel shifting along the horizontal axis. When the object of the transform is measurement data, the variable t is a measurement variable, corresponding to mass-to-charge ratio in the case of a mass spectrum, wavelength in the case of an optical spectrum, and time in the case of a chromatogram. Under wavelet transform, an evaluation function d is computed, which is the inner product of the mother wavelet ψ (t) and the analyzed data x (t) represented by a graph having variable t as the horizontal axis:

$$\begin{matrix}[ Mathematical formula 1 ] & \\ d = {\int }_{- ∞}^{∞} x ( t ) \overline{ψ ( t )} dt & ( 1 )\end{matrix}$$

(wherein the horizontal line drawn above ψ (t) represents a complex conjugate of function ψ (t)). This evaluation function d is a function which takes scale and translation as its parameters. The value of d is computed while varying the scale and translation. In this way, the scale and translation are determined, which yield the maximum value of the evaluation function d obtained through wavelet transform. The mother wavelet ψ (t) having this scale and translation as its parameters will have the highest degree of match to the analyzed data x (t).

An example of a mother wavelet ψ (t) is the Mexican hat function

$$\begin{matrix}[ Mathematical formula 2 ] & \\ ψ ( t ) = ( 1 - {( \frac{t - b}{a} )}^{2} ) exp ( - {( \frac{t - b}{a} )}^{2} / 2 ) . & ( 2 )\end{matrix}$$

Here, a is the scale and b is the translation. In non-patent document 1, the evaluation function d is determined by performing wavelet transform using the Mexican hat function. Moreover, the operation of finding the point at which the maximum value is obtained for the evaluation function d when scale a is fixed at a given value and the measurement variable t is changed, is performed for multiple values of scale a. When the points found in this manner are plotted on a graph having the measurement variable t as the horizontal axis and the scale a as the vertical axis, one or multiple lines extending in the direction of scale a are obtained. Data which has been plotted in lines in this manner is referred to as “ridge lines.” The value of a measurement variable t where the evaluation function d has its maximum value on a ridge line is determined as the location (t value) of a peak in the analyzed data (mass spectrum). This method makes it possible to detect peaks in the analyzed data regardless of the strength or weakness of peaks, etc.

### PRIOR ART DOCUMENTS

### Patent Documents

[Patent document 1] Japanese Unexamined Patent Application Publication H07-098270

### Non-Patent Documents

[Non-patent document 1] Pan Du and 2 others: “Improved peak detection in mass spectrum by incorporating continuous wavelet transform-based pattern matching,” Bioinfomatics, (UK), Oxford University Press, Jul. 4, 2006, Vol. 22, No. 17, pp. 2059-2065

### SUMMARY OF THE INVENTION

### Problem to be Solved by the Invention

In chromatograms, besides true peaks derived from components, there will sometimes be superimposed narrow peak-shaped noise and wide peak-shaped background which rises gradually. With the method described in non-patent document 1, such peak-shaped noise and background are also inadvertently detected as peaks, and it is not possible to discriminate if a detected peak is a true peak or noise or background. The same is true in the case of spectra.

The problem to be solved by the present invention is to provide a peak detection method and data processing device capable of detecting peaks regardless of the peak's strength or weakness and capable of discriminating if a detected peaks is a true peak or not.

### Means for Solving the Problem

The data processing method of the present invention, made to solve the aforementioned problem, is a method of detecting peaks from data of a graph representing change in measured value relative to a measurement variable, characterized in that it comprises:

a) a wavelet transform step in which wavelet transform is performed on the aforementioned data using a mother wavelet having a single maximum value to find an evaluation function having said mother wavelet's scale and translation as parameters; and

b) a peak candidate information acquisition step in which locations of peak candidates in the aforementioned data are found based on the translation at which said evaluation function has its maximum value, and the width of said peak candidates is determined based on the scale corresponding to said peak candidates.

Here, the term measurement variable refers to time in the case of a chromatogram, wavelength in the case of an optical spectrum, and mass-to-charge ratio in the case of a mass-to-charge ratio spectrum; usually, in the graph, the measurement variable is represented on the horizontal axis and the measured values on the vertical axis.

In the present invention, wavelet transform is performed using a mother wavelet having a single maximum value, the locations of peak candidates in the aforementioned data are found based on the translation at which an evaluation function has its maximum value, and the width of the peak candidates is determined based on the scale corresponding to the peak candidates. The width of a peak candidate determined in this manner serves as an index for discriminating whether the peak candidate is a true peak derived from a component in the sample or is something other than a true peak (noise, background, etc.).

While scale is not the same value as the width of a peak candidate, it is correlated to the width in the case of a mother wavelet having a single maximum value. It should be noted that when a mother wavelet has two or more maximum values, it could mean that the mother wavelet has a high degree of match with multiple peaks in the aforementioned data, making it impossible to establish a correspondence between the scale and a data peak. Thus, in the present invention, only mother wavelets having a single maximum value are used.

The Mexican hat function may be mentioned as a typical example of an aforesaid mother wavelet. A function which takes the difference between two Gaussian functions of different width, called difference of Gaussians, can also be used as such a mother wavelet. A method of determining the width of peak candidates will be described below as an example of the case where a Mexican hat function is used as the mother wavelet. Here, data having a single peak with Gaussian distribution will be assumed as the model, and the width of the peak of this model will be assumed to be the unknown value σₚ. Furthermore, when wavelet transform is performed on the data of this model, taking τ_{f} as the scale, the inner product dₜₒₚ can be expressed as

$$\begin{matrix}[ Mathematic formula 3 ] & \\ {d}_{t o p} ( {σ}_{p} , {σ}_{f} ) = \frac{1}{C} \frac{1}{\sqrt{2 π} {( {σ}_{p}^{2} + {σ}_{f}^{2} )}^{3 / 2}} . \\ Here , & ( 3 ) \\ [ Mathematic formula 4 ] & \\ C = - \frac{\sqrt{3}}{{2}^{3 / 2} {π}^{1 / 4} {σ}_{f}^{5 / 2}} . & ( 4 )\end{matrix}$$

Here, the evaluation function

S (σₚ, σ_{f}, m)=σ_{f}^{m} dₜₒₚ (σₚ, σ_{f}) (5)

is introduced, in which the inner product dₜₒₚ is multiplied by the scale σ_{f}^{m}. When this evaluation function S has a maximum value as a function of σ_{f}, that is, when (∂S/∂σ_{f})=0, one obtains

σ_{f}=((5+2 m)/(1-2 m))^{1/2}σₚ (6)

Assuming that m=0 in the evaluation function S of formula (5), the inner product dₜₒₚ itself becomes the evaluation function S. In this case, assuming σ_{fmax} is the scale at the maximum value of evaluation function S, one obtains σₚ=5^{-1/2}σ_{fmax}. Furthermore, assuming that m=−1 in formula (5), one obtains σₚ=σ_{fmax}. The relationship between σ_{fmax} and σₚ can be found in a similar manner also when the value of m is a value other than 0 or −1 as here.

Thus, it is possible to find the evaluation function S from the inner product d obtained through wavelet transform of actual data, generate ridge lines from the obtained evaluation function S, and find the scale σ_{fmax} at which the evaluation function S has its maximum value on the ridge lines to determine the width σₚ of peak candidates.

It should be noted that the width of peak candidates can be determined using a method similar to that described above also when using a wavelet function other than the Mexican hat function.

For the peak detection method of the present invention, it is also possible to perform processing whereby

one or multiple peak candidates are eliminated from the aforementioned data in sequence starting from the peak candidate with the smallest scale value to generate data for wide peak candidate detection; and

said wavelet transform step and said peak candidate information acquisition step are performed after replacing the aforementioned data with said data for wide peak candidate detection.

Generally, peak candidates of greater width have lower peak intensity and are harder to detect, but with the processing using this data for wide peak candidate detection, the influence of narrow width peak candidates is eliminated before performing the wavelet transform step, peak candidate location determination step and peak candidate width determination step, making it easier to detect wide peak candidates. It should be noted that eliminating some of the peak candidates when generating data for wide peak candidate detection does not mean that such peak candidates are discriminated to be false peaks. Such peak candidates should be discriminated as being true or false based on width determined before they are eliminated from the aforementioned data.

The data processing device of the present invention is a device which performs data processing for detecting peaks from data of a graph representing change in measured value relative to a measurement variable, characterized in that it comprises:

a) a wavelet transform unit which performs a wavelet transform on the aforementioned data using a mother wavelet having a single maximum value to find an evaluation function having said mother wavelet's scale and translation as variables; and

b) a peak candidate information acquisition unit which finds locations of peak candidates in the aforementioned data based on the translation at which said evaluation function has its maximum value, and determines the width of said peak candidates based on the scale corresponding to said peak candidates.

### Effect of the Invention

According to the present invention, by performing wavelet transform, peak candidates can be detected regardless of peak strength or weakness, etc., and the widths of the detected peak candidates can be determined. Based on the widths of peak candidates determined in this manner, it is possible to discriminate whether a given peak candidate is a true peak or not.

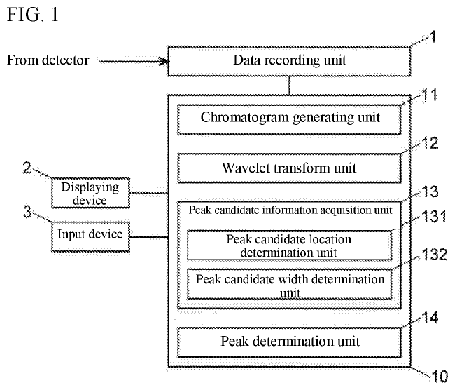

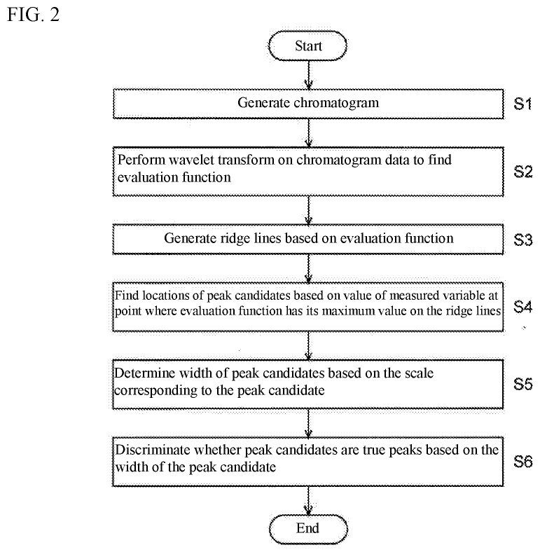

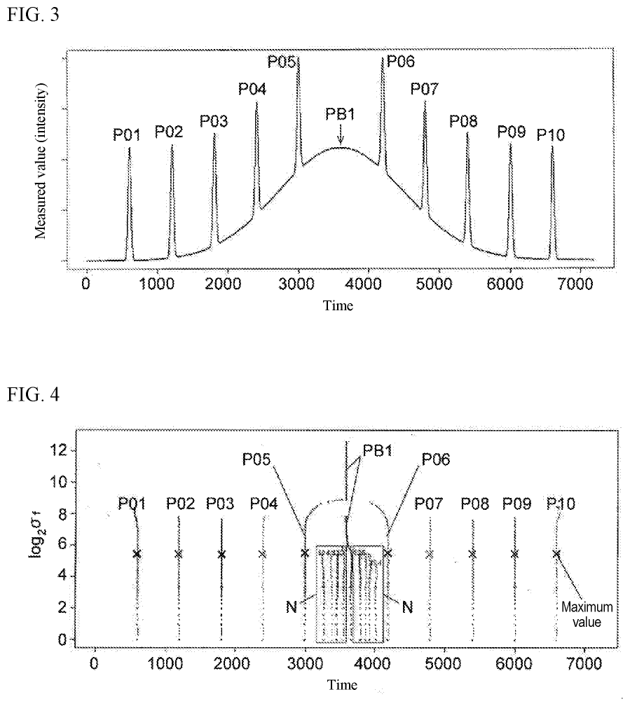

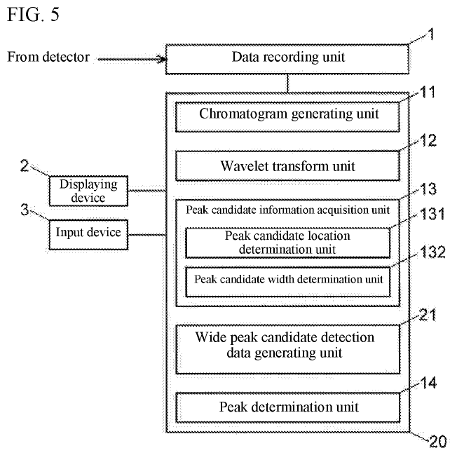

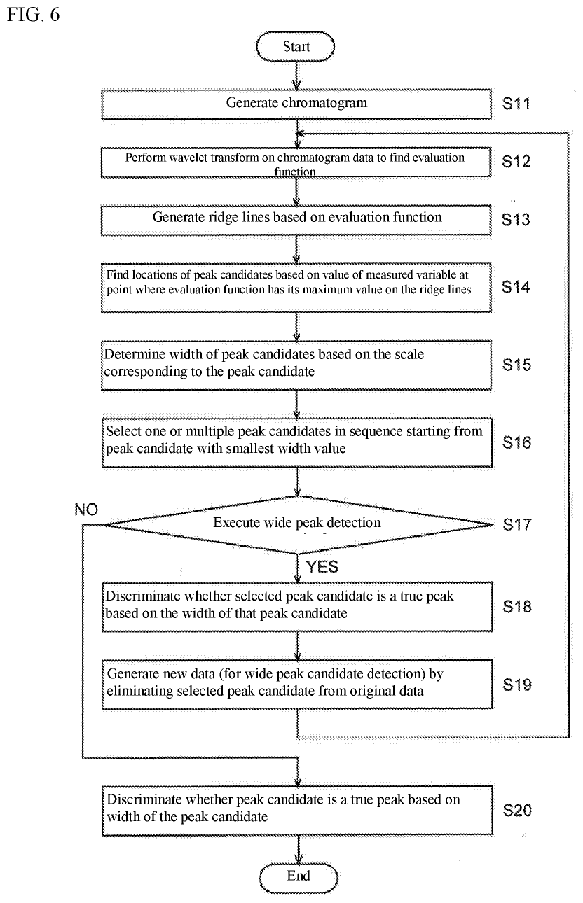

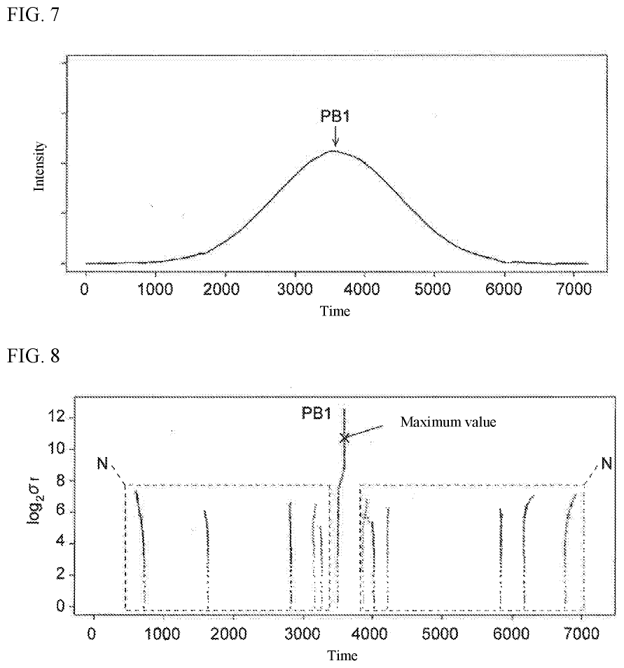

### [BRIEF DESCRIPTION OF THE DRAWINGS]

[FIG. 1] A schematic diagram illustrating a first mode of embodiment of the data processing device of the present invention.

[FIG. 2] A flow chart illustrating a first mode of embodiment of the data processing method of the present invention.

[FIG. 3] A graph illustrating the data subjected to processing in embodiment example 1, in which processing was performed by the data processing method of the first mode of embodiment.

[FIG. 4] A graph illustrating an example in which ridge lines and the location of the maximum value of an evaluation function on said ridge lines have been found based on an evaluation function obtained through wavelet transform in embodiment example 1.

[FIG. 5] A schematic diagram illustrating a second mode of embodiment of the data processing device of the present invention.

[FIG. 6] A flow chart illustrating a second mode of embodiment of the data processing method of the present invention.

[FIG. 7] A graph illustrating an example in which narrow peaks have been eliminated from the original data based on width as determined through wavelength transform in embodiment example 2, in which processing was performed by the data processing method of the second mode of embodiment.

[FIG. 8] A graph illustrating an example in which ridge lines corresponding to wide peaks and the location of the maximum value of an evaluation function on said ridge lines corresponding to wide peaks have been found based on an evaluation function obtained by performing wavelet transform on data from which narrow peaks have been eliminated.

### MODES FOR EMBODYING THE INVENTION

Modes of embodiment of the peak detection method and data processing device of the present invention will be described using FIG. 1 through FIG. 8.

The data processing device 10 of the first mode of embodiment is used together with a data recording unit 1, displaying device 2 and input device 3. The data recording unit 1 is a device which records the data obtained during measurement by a detector possessed by a liquid chromatograph, gas chromatograph, etc., and comprises a hard disk, memory, etc. The data recording unit 1, in the example shown in FIG. 1, is provided outside the data processing device 10, but it may also be provided inside the data processing device 10. The displaying device 2 is a display which displays information during data processing and the results of data processing performed by the data processing device 10. The input device 3 is a device for input of necessary information by the user into the data processing device 10, and comprises a keyboard, mouse, etc.

The data processing device 10 comprises a chromatogram generating unit 11, a wavelet transform unit 12, a peak candidate information acquisition unit 13 and a peak determination unit 14. The peak candidate information acquisition unit 13 comprises a peak candidate location determination unit 131 and a peak candidate width determination unit 132. These units are actually implemented by means of computer hardware, such as a CPU, memory, etc., and software. The first mode of embodiment of the data processing method of the present invention will be described below, along with the functions of each unit of the data processing device 10 of the first mode of embodiment, using the flow chart of FIG. 2.

First, the chromatogram generating unit 11 acquires data from data recording unit 1 and generates a chromatogram C(t) by the same methods as in the prior art (step S1). This chromatogram corresponds to the “data of a graph representing change in measured value” mentioned above, and t is time, which corresponds to the measurement variable mentioned above. When processing is performed on a spectrum, the operation of generating a chromatogram is unnecessary, and it suffices to simply acquire data from the data recording unit 1.

Next, the wavelet transform unit 12 performs wavelet transform on the chromatogram C(t) to find the evaluation function (step S2). For the wavelet transform, the chromatogram C(t) is used as the analyzed data x(t) in formula (1) above, and the inner product is found using a function having a single maximum value, such as the Mexican hat function or difference of Gaussians. The inner product found in this manner may itself be used as the evaluation function, or alternatively, the inner product multiplied by σ_{f}^{m} (here, σ^{f} is scale), as shown in formula (5), may be used as the evaluation function. This evaluation function is a function having scale and translation as its parameters.

Subsequently, the peak candidate information acquisition unit 13 generates ridge lines (step S3) based on the evaluation function found in step S2, and finds the point where the evaluation function has its maximum value on the obtained ridge lines. To generate the ridge lines, the operation of fixing the scale σ_{f} to a given value and then finding the point which yields the maximum value while changing the measurement variable t is performed for multiple values of scale σ_{f}. The ridge lines obtained here are not limited to one, and in many cases, multiple ridge lines will be present, so the point at which the value of the evaluation function has its maximum value on the ridge lines is found separately for each maximum value. The peak candidate location determination unit 131 determines the values of the measurement variable at the maximum value obtained in this manner as locations (times) at which a peak candidate is present on the chromatograph C(t) (step S4), and the peak candidate width determination unit 132 determines the width of peak candidates based on the scale for each peak candidate (step S5). These steps S3 through S5 correspond to the aforementioned peak candidate information acquisition step. It will be noted that steps S4 and S5 may also be carried out simultaneously in parallel, and step S5 may also be performed first. The width of peak candidates, of example, when using formula (5) and formula (6), is a value 5^{-1/2} times the scale at the maximum value when m=0 (the inner product is the evaluation function), and is the same value as the scale at the maximum value when m=−1.

Subsequently, the peak determination unit 27 discriminates, based on the obtained width value, whether the corresponding peak candidate is a true peak or something other than a true peak, such as noise or background (step S6), thereby completing the processing. Whether or not a peak is a true peak is typically determined by setting an upper limited value and lower limit value for width, and discriminating the peak as being true if the obtained width is between the upper limit value and lower limit value, and as not being true if the width is not between these two values. Alternatively, the location (time) may be divided into multiple zones, with an upper limit value and lower limit value for width being set for each zone. In the present mode of embodiment, the peak determination unit 14 performs this discrimination automatically, but it is also possible to display the width values on the displaying device 2 and have a person perform the discrimination instead.

Next, an example (embodiment example 1) will be described, in which peak detection was performed by the data processing method of the first mode of embodiment. In embodiment example 1, the object of processing was the data shown in the graph of FIG. 3. In this data, one can observe ten peaks (P01 through P10), and one peak-shaped profile PB1 which is wider than those peaks.

In the present embodiment example, the inner product was found by performing wavelet transform on this data using the Mexican hat function as the mother wavelet, and that inner product multiplied by σ_{f}⁻¹ (m=−1 in formula (5)) was used as the evaluation function. In this example, the value of scale at which the evaluation function has its maximum value is determined directly as being the width of a peak candidate in the original data.

FIG. 4 shows the results of finding the ridge lines. In FIG. 4, data is displayed as follows, with the horizontal axis of the two-dimensional graph showing time (the measurement variable; same as the horizontal axis of the original data) and the vertical axis showing the scale σ_{f} (where σ_{f} is a base 2 logarithm). First, the scale σ_{f} is fixed at one value and the measurement variable is changed to find the point at which the evaluation function has its maximum value for the given value of scale σ_{f}. This operation is repeated while changing the value of σ_{f} little by little. In this way, one series of points extending in the vertical axis direction appears for each peak candidate in the graph of FIG. 4. These series of points are the ridge lines. The locations of maximum values on the two-dimensional graph of FIG. 4 can then be identified by finding the scale σ_{f} at which the evaluation function has its maximum value for each ridge line.

Based on the graph of FIG. 4, 10 points (the x marks in the figure) at which the evaluation function has its maximum value have been obtained. These 10 points correspond to the peaks P01 through P10, and all have substantially the same value of σ_{f} i.e. width of the original data. There are multiple series of points in this graph labeled N, which constitute noise.

A series of points corresponding to peak-shaped profile PB1 can also be seen in the graph of FIG. 4, but due to the significant the influence of the overlap of P05 and P06 where σ_{f} is large, it was not possible to estimate the width of the peak candidate corresponding to the peak-shaped profile PB1 based on this embodiment example 1. Next, the second mode of embodiment of the present invention will be described, which is a method which allows the width of peak candidates to be estimated even when there is such overlap with other peaks.

A schematic diagram of the data processing device 20 of the second mode of embodiment is shown in FIG. 5. This data processing device 20 has a configuration obtained by adding a wide peak candidate detection data generating unit 21 to the data processing device 10 of the first mode of embodiment. The second mode of embodiment of the data processing method of the present invention will be described below, along with the function of the wide peak candidate detection data generating unit 21.

First, in steps S11 through S15, the same operations are performed as in steps S1 through S5 of the peak processing method of the first mode of embodiment to determine the locations (times) at which peak candidates are present and the widths of the peak candidates.

Next, the wide peak candidate detection data generating unit 21 selects one or multiple peak candidates from among the peak candidates in sequence starting from the one with the smallest determined width (step S16). Subsequently, in step S17, the decision is made as to whether a wide peak detection operation is to be carried out. Methods of making this decision include, for example, deciding YES when it was not possible to find the maximum value as in the case of the aforementioned peak-shaped profile PB 1, or deciding YES until step S17 has been executed a predetermined number of times, regardless of the content of the data.

In the case of YES in step S17, it is determined whether or not a selected peak candidate is a true peak (step S18). Data for the range corresponding to the location and width of the selected peak candidate is then removed from the chromatogram C(t), and the data within that range is interpolated with a straight line or curve to generate data for wide peak candidate detection (step S19). Control then returns to step S12 and the operations of steps S12 through S16 are repeated based on the data for wide peak candidate detection. Here, the number of peaks or peak-shaped profiles in the data for wide peak candidate detection is smaller than in the original data, making it easier to detect wide peaks. The operations of these steps S12 through S16 are repeatedly executed until the decision in step S17 becomes NO.

Furthermore, when the decision in step S17 is NO, the peak determination unit discriminates, for all the peak candidates remaining at the time, whether or not the peak is a true peak (step S20), thereby completing the processing.

An example (embodiment example 2) in which peak detection was performed by the data processing method of the second mode of embodiment will be described below. In embodiment example 2, similarly to embodiment example 1, the object of processing is the data shown in the graph of FIG. 3. First, 10 peaks P01 through P10 were detected by the same method as in embodiment example 1. Then, based on the locations and widths found for the detected peaks P01 through P10, the data for the portion corresponding to peaks P01 through P10 was eliminated from the original data of FIG. 3, and the eliminated portion was interpolated to generate data for wide peak candidate detection. A graph of the generated data for wide peak candidate detection is shown in FIG. 7. Ridge lines were then generated based on this data for wide peak candidate detection. These ridge lines are shown in FIG. 8. One series of points extending in the vertical axis direction is formed corresponding to the peak-shaped profile PB1, and the location at which the evaluation function has its maximum value is identified. There are no other series of points near this series, making it possible to determine the location and width of the peak-shaped profile PB1 without the influence of other peaks, etc. It should be noted that the series of points other than that corresponding to the peak-shaped profile PB1 are noise due to discontinuities, etc. arising during data interpolation.

### DESCRIPTION OF REFERENCE SYMBOLS

2 . . . Data recording unit

2 . . . Displaying device

3 . . . Input device

10, 20 . . . Data processing device

11 . . . Chromatogram generating unit

12 . . . Wavelet transform unit

13 . . . Peak candidate information acquisition unit

131 . . . Peak candidate location determination unit

132 . . . Peak candidate width determination unit

14 . . . Peak determination unit

21 . . . Wide peak candidate detection data generating unit

1. A peak detection method of detecting peaks from data of a graph representing change in measured value relative to a measurement variable, comprising:
a wavelet transform step in which wavelet transform is performed on the data using a mother wavelet having a single maximum value to find an evaluation function having said mother wavelet's scale and translation as parameters;
a peak candidate information acquisition step in which locations of peak candidates in the data are found based on the translation at which said evaluation function has its maximum value, and the width of said peak candidates is determined based on the scale corresponding to said peak candidates; and
a wide peak candidate detection data generating step of generating wide peak candidate detection data by eliminating one or multiple peak candidates from the data in sequence starting with the peak candidate having the smallest scale value among the plurality of peak candidates;
wherein, after executing the wide peak candidate detection data creation step, the data is replaced with the wide peak candidate detection data and the wavelet transform step and the peak candidate information acquisition step are performed again.

2. (canceled)

3. A data processing device, which performs data processing for detecting peaks from data of a graph representing change in measured value relative to a measurement variable, comprising:
a wavelet transform unit which performs a wavelet transform on the data using a mother wavelet having a single maximum value to find an evaluation function having said mother wavelet's scale and translation as variables;
a peak candidate information acquisition unit which finds locations of peak candidates in the data based on the translation at which said evaluation function has its maximum value, and determines the width of said peak candidates based on the scale corresponding to said peak candidates; and
a wide peak candidate detection data generating unit that generates wide peak candidate detection data by by eliminating one or multiple peak candidates from the data in sequence starting with the peak candidate having the smallest scale value among the plurality of peak candidates;
wherein, after generating the wide peak candidate detection data, the data is replaced with the wide peak candidate detection data and the wavelet transform step and the peak candidate information acquisition step are performed again.
